(19) United States
(12) Patent Application Publication
(10) Pub. No.: US 2024/0144075 A1
(43) Pub. Date: May 2, 2024

(54) UPDATING LABEL PROBABILITY DISTRIBUTIONS OF DATA POINTS

(71) Applicant: MICRO FOCUS LLC, Santa Clara, CA (US)

(72) Inventors: Manish Marwah, Santa Clara, CA (US); Hari Manassery Koduvely, Ottawa (CA); Mahsa Khosravi, Ottawa (CA); Maria Pospelova, Ottawa (CA); Martin Fraser Arlitt, Calgary (CA)

(21) Appl. No.: 17/976,480

(22) Filed: Oct. 28, 2022

(51) Int. Cl. G06N 20/00; G06F 16/28; G06N 7/00

(52) U.S. Cl. CPC G06N 20/00; G06F 16/285; G06N 7/005

(57) ABSTRACT

One or more iterations are performed. Each iteration includes calculating, for each of a number of data points that each have a label probability distribution, a label quality measure based on the label probability distribution of the data point. Each iteration includes updating the label probability distribution of each of at least one of the data points using either or both of a classification technique and a constrained clustering technique based on the data points and the label quality measure of each data point.

### BACKGROUND

Many different types of physical and other systems can suffer from infrequent or rare anomalies that if not detected and ameliorated in a timely manner can result in undesirable consequences. For example, computing systems may be subjected to malicious infiltration or other security incident that if not detected can result in the compromise of confidential information. As another example, the software and hardware components of a computing system may periodically fail, and if such failure is not predictively detected and the components in question replaced or updated then unavailability of the services that the system provides and/or loss of information that the system maintains may occur. Other examples of systems that may suffer from infrequent anomalies can include the seismological “system” of the Earth, which can suffer from earthquakes; financial systems, which can suffer from shocks that affect their functional integrity; and so on.

### BRIEF DESCRIPTION OF THE DRAWINGS

FIG. 1 is a diagram of an example system in which a computing device can detect and resolve anomalies from log events generated by and/or regarding devices.

FIG. 2 is a diagram of an example process that can be performed in the system of FIG. 1 for detecting and resolving anomalies from log events generated by and/or regarding devices using a machine learning model.

FIG. 3 is a diagram of an example non-transitory computer-readable data storage medium storing program code that is executable to perform an iterative process for generating training or validation data for a machine learning model that can be used in the process of FIG. 2.

FIG. 4A is a diagram of an example process for setting label probability distributions for data points in the process of FIG. 3.

FIGS. 4B and 4C are diagrams of example label probability distributions for a data point having a manually assigned label and for a data point not having a manually assigned label, respectively.

FIG. 5 is a flowchart of an example method for calculating a label quality measure for a data point in the process of FIG. 3.

FIG. 6A is a flowchart of an example method for using a probabilistic classifier in the process of FIG. 3 to update label probability distributions for data points that do not have manually assigned labels.

FIG. 6B is a flowchart of an example method for using constrained clustering in the process of FIG. 3 to update label probability distributions for data points that do not have manually assigned labels.

FIG. 7 is a flowchart of an example method for updating label probability distributions in the process of FIG. 3 for data points having low label quality measures and for which manually assigned labels have been requested and received.

FIG. 8 is a flowchart of an example method for determining whether the iterative process of FIG. 3 has been completed.

FIG. 9 is a flowchart of an example method for training and/or validating a machine learning model using the data generated in FIG. 3 and for then using the model.

### DETAILED DESCRIPTION

As noted in the background, different types of systems can suffer from anomalies. Timely and/or predictive detection of such anomalies can ensure that undesirable consequences do not occur. Anomaly detectors can be used to detect anomalies. An anomaly detector may be considered as an algorithm, technique, and so on, that receives data from and/or regarding a target system, and processes the data to output an anomaly score indicating the likelihood of an anomaly at the target system. The terminology “likelihood of an anomaly at the target system” encompasses the likelihood that an anomaly has occurred, as well as the likelihood that an anomaly will occur soon, depending on the anomaly detector and/or the target system in question.

For example, as to the detection of malicious infiltration or other security incident at a target computing system, an anomaly detector may output an anomaly score indicative of the likelihood as to whether such malicious infiltration has occurred. The anomaly detector may receive as input the activity logs of network communication to and from the target system, utilization logs of the software components and/or hardware components of the target system, as well as other information. The anomaly detector may process such received information to generate an anomaly score indicating a likelihood that malicious infiltration has occurred. If the likelihood is greater than a threshold, for instance, then the target system may be reconfigured as a remedial action to ameliorate the detected anomaly.

As another example, as to the predictive detection of hardware and/or software component failure of a target computing system, an anomaly detector may output an anomaly score indicative of whether such a component is likely to fail soon. The anomaly detector may receive as input logs regarding the component in question, as well as other components of the target system. The anomaly detector may process the received information to generate an anomaly score indicating a likelihood that the component is on the verge of failure. If the likelihood is greater than a threshold, then the component may be replaced to avoid undesired disruption of the services that the target system provides.

Anomaly detectors may rely on or use artificial intelligence techniques to assess whether input data is indicative of an anomaly. One type of artificial intelligence is machine learning. Machine learning is a technology that permits computing systems the ability to “learn” (i.e., progressively improve in performance) as increased amounts of data are provided to the underlying machine learning model, without having to be explicitly programmed. Over time, as a machine learning model has been exposed to large amounts of input and output data, the model can provide accurate prediction of output data for given input data. Machine learning can be considered as particular to the capabilities of a computing device, insofar as the underlying models are intractable for human users to perform.

A machine learning model may be a supervised machining learning model, which has to first be trained using prelabeled training data before the model can make predictions. For example, data points, such as log entries relating to and/or generated by devices, may be manually labeled with labels denoting whether the data points are indicative of various anomalies. The machine learning model may then be trained from the provided prelabeled training data, such that the model can be subsequently applied to input data in order to label the input data, including the probability that the labels that are output are accurate for the input data.

The accuracy of a supervised machine learning model is therefore predicated at least in part by the amount, diversity, and accuracy of the training data on which basis the model is trained and/or validated. If an insufficient amount and/or diversity of training data is used, the machine learning model may not be robust in making predictions for input data that is significantly different than the training data. Similarly, if the training data itself is inaccurate, in that the labels assigned to the training data are incorrect for at least a portion of the training data, then the machine learning model's accuracy may suffer.

Generating training data in many domains, however, is laborious. For example, in the case of security anomalies detected from log events generated by and/or relating to devices, a domain expert (e.g., a user who is an expert in identifying security anomalies) may have to painstakingly manually label each such data point. A data point may be in the form of a feature vector having values for different input features. The domain expert thus has to inspect the values of the different inputs features of a data point, and accurately assign a label to the data point.

A rich data set may require thousands, tens of thousands, hundreds of thousands, or even more labeled data points. Even employing a large number of experts to label the data points can therefore require an inordinate amount of time. Moreover, mental fatigue can occur during manual data point labeling, introducing labeling errors that can affect the performance of a machine learning model trained and/or validated on the basis of the labeled data points.

Techniques described herein ameliorate these issues, by labeling a large number of initially unlabeled data points using a small number of data points that have been manually labeled. A set of data points numbering in the tens or hundreds of thousands or more can thus include a smaller number of data points that a domain expert has manually labeled, such as in the hundreds, and a larger number of data points that no domain experts have manually labeled. Over a number of iterations, the described techniques label the larger number of data points with an accuracy that can approach that as if a domain expert labeled the data points.

The techniques are described herein in general relation to automated accurate labeling of data points. Such labeled data points can form a training data set on which basis a machine learning model is then trained and/or validated. Such a machine learning model can be used to identify anomalies within log events received by or relating to devices, so that that remedial actions can be performed to resolve the anomalies. However, the described techniques are not limited to machine learning-oriented anomaly identification. Rather, the techniques are applicable to any classification problem in general that uses machine learning.

Furthermore, the terminology “anomaly detection” is used herein in a broad manner. Anomaly detection can include unsupervised machine learning techniques that can permit the detection of zero-day (i.e., previously unknown) cyberattack vectors, in which case the techniques described herein are primarily used to generate labeled data points for validating the machine learning models. However, anomaly detection can include supervised machine learning techniques as well.

Such supervised machine learning techniques in the case of cybersecurity can include classification of attack types (such as per the MITRE ATT&CK framework), malware types, vulnerability types, and bot types. These classification-oriented techniques are considered as anomaly detection insofar as they provide information regarding anomalies (i.e., they classify the anomalies). The techniques may match provided data input to different type classes, for instance.

Even more generally, then, anomaly detection as used herein can include usage of any type of machine learning technique, including supervised, semi-supervised, unsupervised, and self-supervised. Anomaly detection as used herein can provide different types of output, including regression, multi-class, multi-label, and structured output. Anomaly detection can include classifying, localizing, and explaining (i.e., providing information regarding) anomalies.

As noted above, however, the techniques described herein are not limited to anomaly detection, and may be applied, for instance, to other classification problems as well. In the context of cybersecurity, such applications include entity resolution (regardless of whether two entities are in different datasets or not). Other examples include network traffic classification, log analytics (classifying logs into categories), recommending security configuration settings (which may then be manually or automatically invoked), and predicting and forecasting a state of health indicator (on which basis an action may be manually or automatically performed to resolve predicted health degradation).

Predicting and forecasting a state of health indicator can be in terms of performance, security, or both. The health indicators may concern individual computing devices (e.g., computers such as servers) as well as other equipment. The health indicators may further or instead concern entities more holistically or at a higher level of granularity, such as data centers and enterprise and other types of networks.

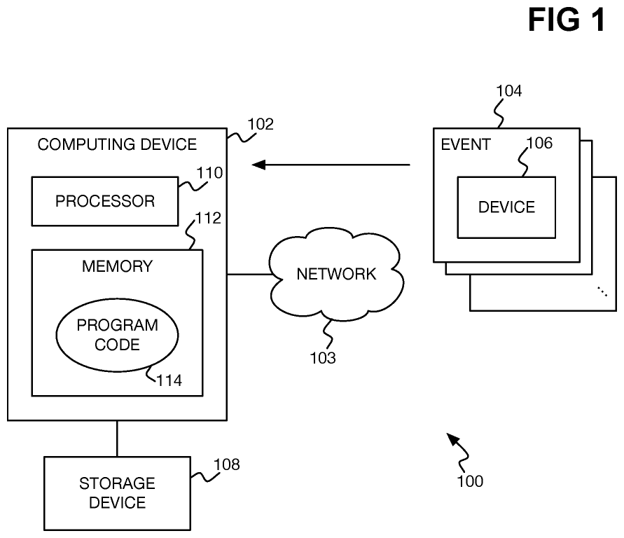

FIG. 1 shows an example system 100. The system 100 includes a computing device 102 communicatively connected to a network 103 and over which the device 102 can receive log events 104 relating to devices 106. The computing device 102 may receive the log events 104 directly from the devices 106, or in another manner, such as by a proxy that directly collects the log events 104 and periodically sends the log events 104 to the device 102. The computing device 102 can store the received log events 104 on a storage device 108, which is depicted as external to the device 102, but which instead may be internal to the device 102.

The devices 106 may be the devices of an enterprise or other organization, for instance, that are interconnected with one another over the Internet and/or internal networks. The devices 106 may be devices like servers, for example, which can provide diverse services, including email, remote computing device access, electronic commerce, financial account access, and so on. Individual server devices 106, as well as other devices 106 including other network devices and computing devices other than server computing devices, may output log events 104 indicating status and other information regarding their hardware, software, and communication.

Such communication can include intra-device and inter-device communication as well as intra-network (i.e., between devices on the same network) and inter-network (i.e., between devices on different networks, such as devices connected to one another over the Internet) communication. The terminology log event is used generally herein, and encompasses all types of data that such devices 106, or hosts or sources, may output. For example, such data that is encompassed under the rubric of log events includes that which may be referred to as messages, as well as that which may be stored in databases or files of various formats.

To detect potential security vulnerabilities and potential cyberattacks by nefarious parties, as well as to detect other types of anomalies, such as device misconfigurations and operational and/or business issues, the computing device 102 therefore collects voluminous amounts of data in the form of log events 104 for analysis in an offline or online manner. The computing device 102, which may itself by one or multiple server computing devices, thus includes a processor 110 and a memory 112 storing program code executable by the processor 110 to detect anomalies within the log events 104 received over the network 103 and stored on the storage device 108.

The network 103 in this respect may be or include the Internet, an intranet, an extranet, a wide-area network (WAN), a local-area network (LAN), an Ethernet network, a wired network, and/or a wireless network, among other types of networks. The storage device 108 may be one or multiple hard disk drives (HDDs) and/or solid-state drives (SSDs), organized in an array, such as a redundant array of independent disks (RAID), or in a storage-area network (SAN), for instance. Once the computing device 102 has identified an anomaly based on the log events 104, the device 102 may perform a remedial action on or in relation to one or more of the devices 106 to resolve the anomaly.

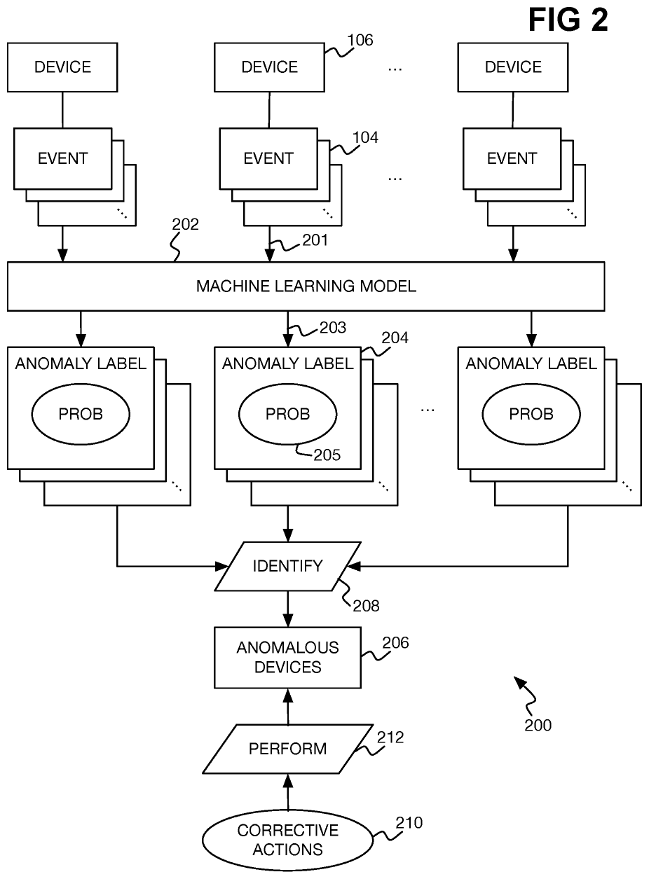

FIG. 2 shows an example process 200 that can be performed within the system 100 to identify anomalies from the log events 104 relating to the devices 106. Each device 106 may generate or may otherwise have related log events 104. The log events 104 may be individually or in groups considered data points. For example, the log events 104 may each be considered a feature vector having values for different features. A log event 104 may identify a given device 106, for instance, and provide information regarding the device 106, such as environmental conditions (time, temperature, humidity), communication information (another device 106 to which the device 106 is communicating, protocol, packet identifier, subnet, and so on). Each different information is a feature of the feature vector, and the value of the information is the value for that feature.

The log events 104 are input (201) to a machine learning model 202. The machine learning model 202 is a model that has already been trained and validated, in the case of a supervised machine learning model. Examples of such a machine learning model 202 can include a deep neural network, a convolutional neural network, a linear regression model, and so on. The machine learning model 202 can instead be an unsupervised machine learning model. Examples of such a machine learning model 202 can include a principal component analysis (PCA) model, an autoencoder model, a clustering model, a Gaussian mixture model, and so on. For each log event 104 (or for a group of log events 104 where such a group constitutes an individual data point to which the machine learning model 202 is applied), the machine learning model outputs (203) a number of anomaly labels 204 with respective probabilities 205.

The set of all anomaly labels 204 is the set of all the different types, or classes, of anomalies that the machine learning model 202 is able to predict from the log events 104. The machine learning model 202 for a given data point may output the probability 205 that the data point exhibits the anomaly of each anomaly label 204. That is, if there are k total anomaly labels 204, the machine learning model 202 may output k probabilities 205 for each data point. The probability 205 for an anomaly label 204 is the likelihood that the data point in question has the anomaly corresponding to that label 204.

In another implementation, the machine learning model 202 may just output one anomaly label 204 for each data point, which is the label 204 for which the data point has a highest probability 205. The machine learning model 202 may output just the anomaly labels 204 for a data point for which the probabilities 205 are greater than a threshold, or may output a specified number of anomaly labels 204 for which a data point has the highest probabilities 205. As has been noted, a data point can constitute a single log event 104, or a group of log events 104. The log events 104 in this latter case may be dynamically or statically grouped.

From the anomaly labels 204 and their probabilities 205 as predicted by the machine learning model 202, one or multiple anomalous devices 206 may be identified (208) from the devices 106 to which the log events 104 relate. For example, anomaly labels 204 having probabilities 205 greater than a threshold may be indicative that the devices 106 to which the anomaly labels 208 pertain (insofar as the labels 208 were output from log events 104 concerning the devices 106) are anomalous devices 206. In other implementations, different types of anomaly labels 204 and their associated probabilities 205 may be analyzed in order to identify anomalous devices 206.

For example, one device 106 having a given anomaly label 204 with a probability 205 greater than a threshold may not be considered an anomalous device 206. However, if more than a specified number of such devices 106 each have a probability 205 for this anomaly label 204 greater than the threshold, then the devices 106 may be considered anomalous devices 206. As another example, a device 106 may have a first anomaly label 204 with a probability 205 greater than a first threshold. However, if the device 106 does not also have one or more second anomaly labels 204 that each have a probability 205 greater than a second threshold, then the device 106 may not be considered anomalous. That is, groups of devices 106 and groups of anomaly labels 204 may be considered in identifying anomalous devices 206.

An anomaly device 206 is a device 106 that is suffering from an anomaly. For example, in the security context, the anomaly may be that the device 106 has been nefariously infiltrated or is the subject of a cyberattack. As another example, in the operational context, the anomaly may be that the device 106 is malfunctioning, or performing correctly but less than optimally (e.g., slower than expected, at higher temperature than expected, and so on). Therefore, corrective actions 210 can be performed (212) on or in relation to the anomalous devices 206.

Such correction actions 210 can be performed automatically, without user assistance. The actions 210 can include restarting or rebooting the devices 206, or reconfiguring the devices 206 to a last known working or a default configuration. If an anomalous device 206 is one of a number of devices 106 that performs the same type of functionality, the device 206 may be shutdown, or disconnected from the network or otherwise disconnected from the other devices 106. The anomalous device 206 may be automatically replaced with a comparable hot-spare device 106 that is not currently being used. If the anomaly is a cyberattack, security measures may automatically be put into place. If the anomaly is a security vulnerability, the device 206 may be turned off or removed from service to resolve the anomaly.

The process 200 thus can be performed in the system 100 to identify and resolve anomalies within devices 106 from log events 104 concerning the devices 106. The process 200 employs a machine learning model 202 that is applied to data points (i.e, individual or groups of events 104) to yield anomaly labels 204 with associated probabilities 205, on which basis anomalous devices 206 can then be identified. This means that the machine learning model 202 should be accurate, which in turn means that the machine learning model 202 should be accurately trained and validated. Accurate training and validation of the machine learning model 202 can require accurately labeling training data, which is now described in detail.

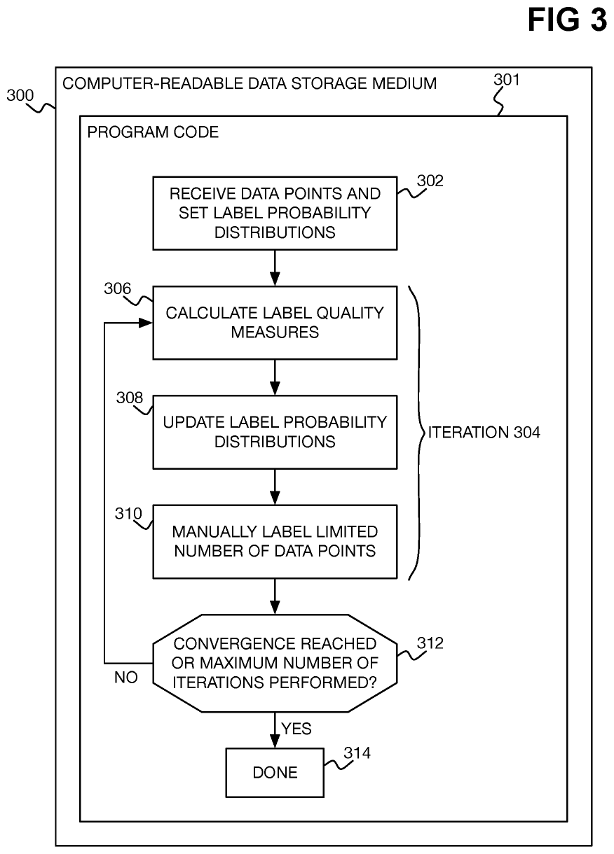

FIG. 3 shows a non-transitory computer-readable data storage medium 300 storing program code 301 executable by a processor, such as the processor 110 of the computing device 102, to perform processing. The processing is for labeling initially unlabeled data points with labels. Once the processing has been performed, the labeled data points can then be used to train or validate a machine learning model such as the machine learning model 202.

The processing includes receiving data points and setting label probability distributions for their data points (302). For example, there may be a total of N+Nₗ data points, including a larger number of N initially unlabeled data points and a smaller number of Nₗ data points that have already been manually labeled by a domain expert or other user, or in another manner, where Nₗ<<N. There may be a total of k labels. Each data point i has a label probability distribution Pᵢ, where the probability that any label j is correct for the data point i is Pᵢ(j). Each data point i definitely has a label, meaning that Σⱼ₌₁^{k} Pᵢ(j)=1.

The label probability distribution for each of the Nₗ data points that have manually assigned labels may be fixably set (e.g., clamped), in that the probability distribution does not vary and is not updated once the distribution has been set. This is because it is assumed that the label manually assigned to each such data point is correct. By comparison, the label probability distribution for each of the N data points that are initially unlabeled may be initially set, in that the probability distribution is likely to be changed and be updated after the distribution has been set. This is because no label has been initially assigned to any such data point, and the purpose of the processing is to ultimately assign each of these data points with a correct label.

The processing includes performing one or number of iterations 304. Each iteration 304 includes calculating label quality measures for the data points (306). That is, a label quality measure Qi is calculated for each data point i. The label quality measure specifies the likelihood that the label probability distribution of a data point is accurate. Stated another way, the label quality measure is indicative that the label probability distribution of a data point specifies the correct label for that data point. The label quality measure is further a measure of confidence in the label in question for the data point.

The label quality measure for each of the Nₗ data points that have manually assigned labels may be calculated once, as part of (or prior to) the first iteration 304. Because the label probability distribution of each such data point does not change, the label quality measure for each of these data points does not change and therefore does not need to be recalculated again. By comparison, the label quality measure for each of the N data points that are initially labeled may be calculated in each iteration 304, since the label probability distribution of each such data point may change as each iteration 304 is performed.

Each iteration 304 includes updating the label probability distribution of each of at least one of the N data points that were initially unlabeled (308). In the first iteration 304, all of the N data points may have their label probability distributions updated. In subsequent iterations 304, fewer of the N data points may have their label probability distributions updated (and their label quality measures recalculated). The label probability distributions may be updated using either or both of a classification technique or a constrained clustering technique.

For example, in one implementation, just a classification technique or just a constrained clustering technique may be used in each iteration 304. In another implementation, the classification technique may first be performed, followed by the constrained clustering technique (or vice-versa), in each iteration. In another implementation, the classification technique may be performed in odd-numbered iterations, and the constrained clustering technique performed in even-numbered iterations (or vice-versa).

Each iteration 304 may include manually labeling a limited number of the initially unlabeled N data points that have the lowest label quality measures (310). Such manual labeling can be performed by the same or different domain expert that labeled the initially manually labeled Nₗ data points, or otherwise in the same or different manner as to how the Nₗ data points were labeled. Any of the N data points that is subsequently manually labeled in an iteration 304 has its label probability distribution fixably set in the same manner in which the Nₗ data points had their label probability distributions fixably set. None of the manually labeled of the N data points has its label probability distribution subsequently updated after being fixably set.

If convergence of the label probability distribution of the N data points before and after having been updated in 308 of the most recent iteration 304 has occurred, or if the maximum number of iterations 304 has been performed (312), then the processing is finished (314). In this case, the final label probability distribution Pᵢ of each data point i of the N data points can be used to determine the label j most accurately describes (i.e., is correct for) the data point i. This is the label j having the highest probability Pᵢ(j) for the data point i. If convergence has not yet been reached and if the maximum number of iteration 304 has not yet been performed (312), the processing is repeated with a further iteration 304, beginning at 306.

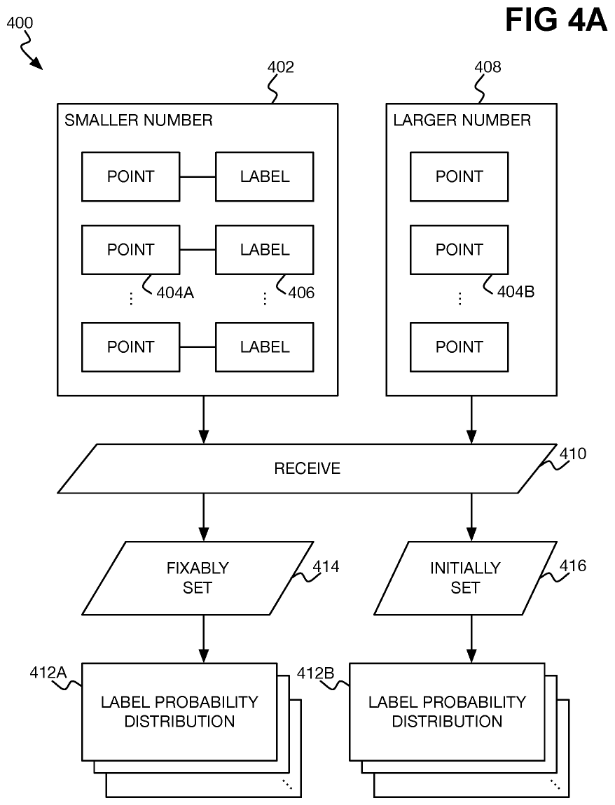

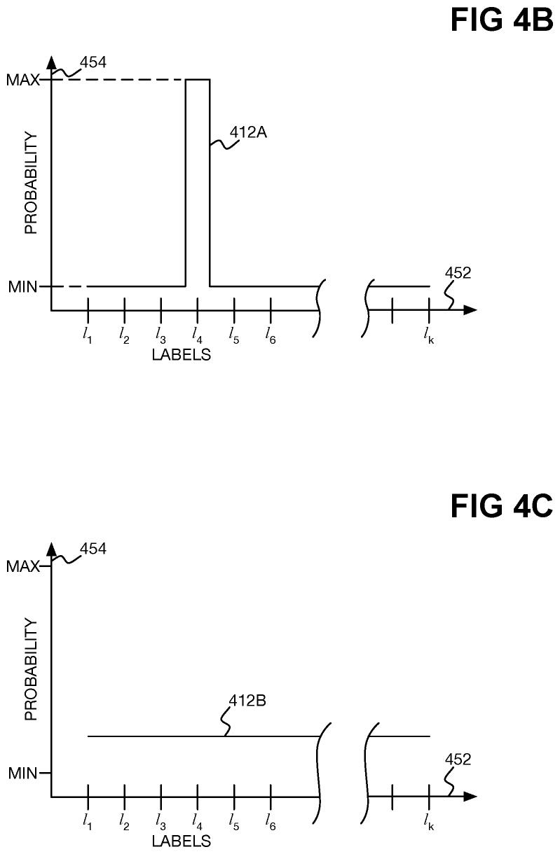

FIG. 4A shows an example process 400 for receiving data points and setting their label probability distributions in 302 of FIG. 3. A smaller number 402 of Nₗ data points 404A that already each have a manually assigned label 406 (viz., one of the k labels), and a larger number 408 of N>>Nₗ data points 404B that are initially unlabeled (e.g., that do not have manually assigned labels) are received (410). The label probability distribution 412A for each data point 404A is fixably set (414), in that once the distributions 412A have been set, they are not subsequently updated. The label probability distribution 412B for each data point 404B, by comparison, is initially set (416), in that the distributions 412B can subsequently be updated.

FIG. 4B shows example fixable setting of a label probability distribution 412A for a particular data point 404A that when received in 410 already had its label manually set. The x-axis 452 denotes the k labels l₁, l₂, l₃, l₄, l₅, l₆, . . . , lₖ, whereas the y-axis 454 denotes the probability Pᵢ(j) for each such label j, such that the collection of the probability Pᵢ(j) for every different label j constitutes the label probability distribution 412A. In the example of FIG. 4B, the data point 404A in question has been manually assigned the label l₄. Therefore, the label probability distribution 412A has been fixably set such that the probability at the manually assigned label is at a maximum (e.g., one or near one), and the probability at every other label is at a minimum (e.g., zero or near zero). That is, in the example, the probability Pᵢ(l₄) is at a maximum, and the probability Pᵢ(j) for each label j≠l₄ is at a minimum.

FIG. 4C shows an example of initial setting of a label probability distribution 412B for each data point 404B that when received in 410 is initially not assigned with a label. The x-axis 452 again denotes the k labels l₁, l₂, l₃, l₄, l₅, l₆, . . . , lₖ, where the y-axis 454 again denotes the probability Pᵢ(j) for each such label j, such that the collection of the probability Pᵢ(j) for every different label j constitutes the label probability distribution 412B. The label probability distribution 412B is initially set to a uniform probability distribution, such that the probability Pᵢ(j) for every label j is set to the same value. Because Σⱼ₌₁^{k} Pᵢ(j)=1, this means that the probability Pᵢ(j) for every label j is set to 1/k.

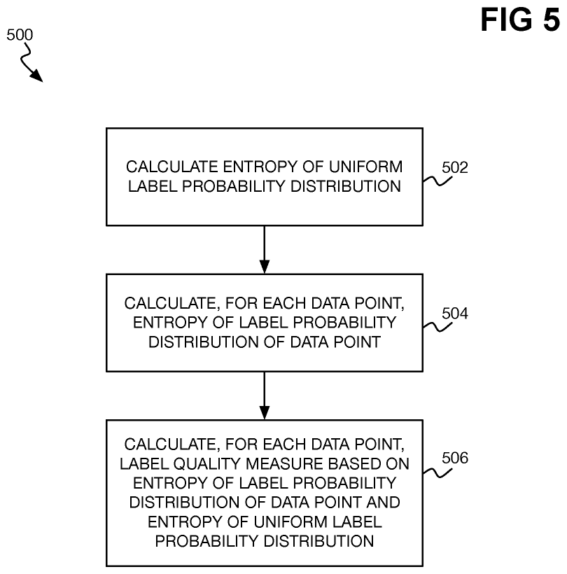

FIG. 5 shows an example method 500 for calculating a label quality measure for each data point 404A and 404B in 306 of FIG. 3. As noted, the label quality measure for each data point 404A that was initially manually labeled may be calculated just once, during the first iteration 304 or prior to the first iteration 304. By comparison, the label quality measure for each data point 404B that was initially unlabeled may be calculated during each iteration 304.

The method 500 includes calculating the entropy of a uniform label probability distribution (502). If a uniform probability distribution over k labels is represented as Uₖ, the entropy of the uniformity probability distribution can be represented as H(Uₖ). (It is noted that the uniform label probability is that the initial label probability distribution 412B of each initially unlabeled data point 404B in FIG. 4C.) Because the uniform label probability distribution does not change, the entropy of the uniform label probability distribution also does not change, and therefore may be calculated just once. The entropy of the uniform label probability distribution may be calculated as the Shannon entropy of this distribution in one implementation.

The method 500 includes calculating, for each data point 404A/404B, the entropy of the label probability distribution 412A/412B of the data point 404A/404B in question (504). Because the label probability distribution 412A of each data point 404A does not change, the entropy of the distribution 412A of a data point 404A has to be calculated just once. Because the label probability distribution 412B of each data point 404B can change each iteration 304, the entropy of the distribution 412B of a data point 404B may have to be calculated in every iteration 304. The entropy of the label probability distribution 412A/412B of each data point 404A/404B may also be calculated as the Shannon entropy in one distribution, and for a data point i having label probability distribution Pᵢ is represented as H(Pᵢ).

The method 500 includes calculating, for each data point 404A/404B, a label quality measure based on the entropy of the label probability distribution 412A/412B of the data point 404A/404B in question and based on the entropy of the uniform label probability distribution (506). For example, a linear measure for a data point i may be defined as

$${Q}_{i} = \frac{H ( {U}_{k} ) - H ( {P}_{i} )}{H ( {U}_{k} )} .$$

H(Pᵢ) is bounded between zero and H(Uₖ), and therefore the label quality measure Qi is bounded between one and zero, with zero corresponding to lowest quality and one corresponding to highest quality. Note that since each data point 404B initially has a label probability distribution 412B that is uniform, this means that the label quality measure of every data point 404B is zero in the first iteration 304.

In other situations, a non-linear relationship between quality and entropy may be employed, such as in the case in which more weight should be assigned to higher quality data points and lesser weight to lower quality points. A first such non-linear label quality measure may be Gaussian-based, such as

$${Q}_{i} = {e}^{- \frac{{H ( {P}_{i} )}^{2}}{{( b \cdot H ( {U}_{k} ) )}^{2}}} .$$

A second such non-linear label quality measure may be hyperbolic-based, such as

$${Q}_{i} = {( \frac{H ( {U}_{k} )}{b} \cdot H ( {P}_{i} ) + 1 )}^{- 1} .$$

A third such non-linear label quality measure may be Cauchy-based, such as

$${Q}_{i} = {( {( \frac{H ( {U}_{k} ) \cdot H ( {P}_{i} )}{b} )}^{2} + 1 )}^{- 1} .$$

In these examples, the parameter b determines the bandwidth of the non-linear curve.

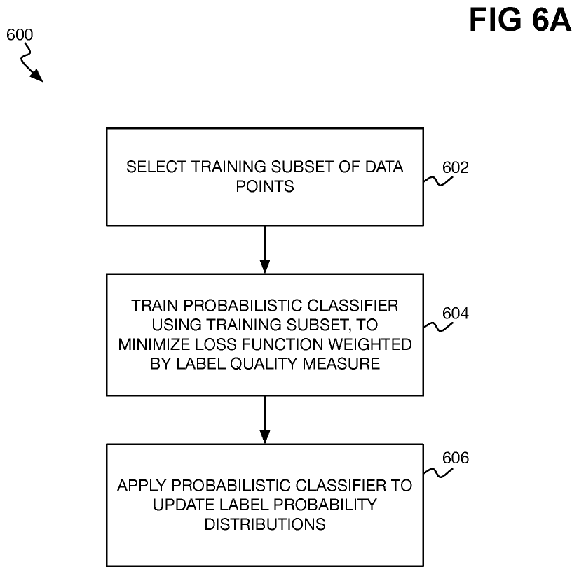

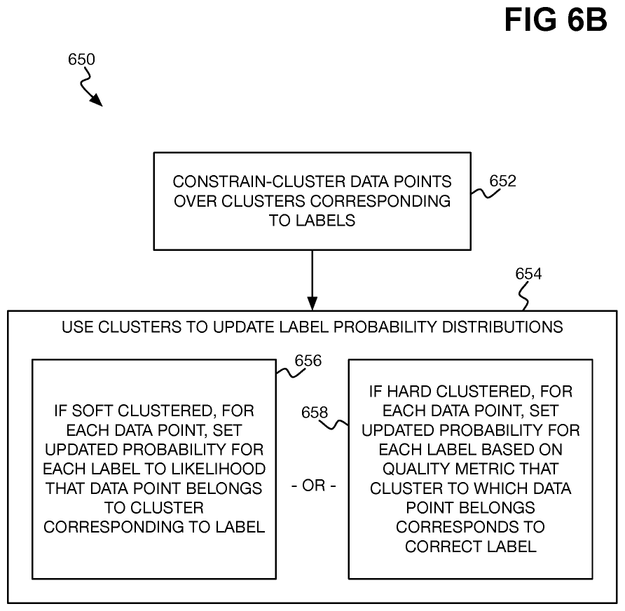

FIG. 6A shows an example method 600 for updating the label probability distributions 412B in 308 of FIG. 3 using a classification technique. The method 600 includes selecting a training subset of the data points 404A and 404B (602). In the initial iteration 304, the training subset is selected as or from the smaller number 402 of data points 404A, since the label quality measure of each data point 404B is initially zero. In subsequent iterations 304, both data points 404A and 404B may be part of the training subset.

For instance, every data point 404A and 404B having a label quality measure greater than a threshold may be selected as part of the training subset, or a specified number of the data points 404A and 404B having label quality measures greater than the threshold may be selected as the training subset. As one example, of the data points 404A and 404B having label quality measures greater than a threshold, a specified number of the data points 404A and 404B having the highest such measures may be selected as the training subset.

A probabilistic classifier is then trained using the training subset (604). The loss function that the probabilistic classifier is trained to minimize is specifically weighted by a label quality measure. Examples of probabilistic classifiers that can be employed include naïve Bayes classifiers, logistic regression classifiers, and multilayer perceptron classifiers. Example loss functions (as weighted by label quality measure) that may be used include the 0-1 loss function, the cross-entropy or log loss function, and the hinge loss function.

Once the probabilistic classifier has been trained, the classifier is applied to update the label probability distributions 412B for the data points 404B (606). Specifically, the classifier is applied to each data point 404B, yielding an updated probability for each label that the label is correct for the data point 404B in question. That is, when applied to a data point 404B, the classifier yields a probability for each label j, 1 . . . k. The updated label probability distribution 412B for the data point 404B is thus the collection of these probabilities, from label l₁ through label lₖ.

FIG. 6B shows an example method 650 for updating the label probability distributions 412B in 308 of FIG. 3 using a constrained clustering technique. The method 600 includes constrain-clustering the data points 404A and 404B over clusters corresponding to the k labels (652). That is, in one implementation the number of clusters is set to the number of labels, such that there are k clusters respectively corresponding to the k labels. In another implementation, there may be more clusters than labels, such that the clusters are mapped to the k labels. That is, more than one cluster can map to the same label, but each cluster maps to just one label.

Furthermore, the clustering is constrained in that the data points 404A and 404B having a high probability of belonging to the same cluster (i.e., a probability greater than a threshold) are constrained to the same cluster. The clusters are used to update the label probability distributions 412B of the data points 404B (654). The clustering technique itself may be soft clustering or hard clustering.

In soft clustering, each data point 404B has a likelihood that the data point 404B belongs to each cluster. Therefore, if soft clustering is used, for each data point 404B, the updated probability that each label is correct for the data point 404B is set within the label probability distribution 412B to the likelihood that the data point 404B belongs to the cluster corresponding to the label in question (656). That is, for a data point 404B, there is a likelihood for the cluster corresponding to each label j, 1 . . . k. The updated label probability distribution 412B for the data point is thus the collection of these likelihoods, from the cluster for label l₁ through the cluster for label lₖ.

In hard clustering, each data point 404B belongs to just one cluster, but there is a quality metric, or probability, that the cluster corresponds to the correct label for the data point 404B. Hard clustering can be used just if there is a quality metric or a measure of distance from cluster centers, so that the hard cluster labels can effectively be transformed into soft cluster labels. If hard clustering is used, for each data point 404B, the updated probability that each label is correct for the data point 404B is set within the label probability distribution 412B based on the quality metric that the cluster to which the data point 404B belongs corresponds to the correct label for the data point 404B (658). For example, the quality metric may be the silhouette coefficient, and can be a probability 0<c≤1. In this case, the label probability distribution 412B is updated such that for the label corresponding to this cluster, the probability is set to c, and the probability for every other label is set to

$$\frac{1 - c}{k - 1} ,$$

since Σⱼ₌₁^{k} Pᵢ(j)=1.

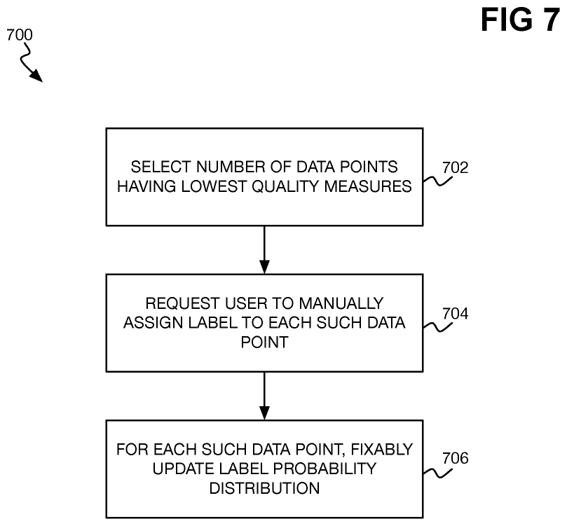

FIG. 7 shows an example method 700 for manually labeling a limited numbers of data points 404B in 310 of FIG. 3. The method 700 includes selecting a number of the data points 404B having the lowest quality measures (702). For example, if there is less than a specified number of data points 404B having quality measures lower than a threshold, then all these data points 404B may be selected. By comparison, if there is more than a specified number of data points 404B having quality measures lower than this threshold, then a specified number of data points 404B having the lowest quality measures may be selected. This ensures that a domain expert is not requested to manually label too many data points 404B, or to manually label data points 404B that have been deemed as having sufficient quality measures (i.e., greater than the threshold).

A domain expert or other user is then requested to manually assign a label to each selected data point 404B (704). The label probability distribution 412B for each data point 404B is fixably updated based on the label that has been manually assigned (706). For example, the label probability distribution 412B can be fixably set such that the probability at the manually assigned label is at a maximum (e.g., one or near one), and the probability at every other label is at a minimum (e.g., zero or near zero).

Once a data point 404B has been manually labeled in the method 700, it is treated in subsequent iterations 304 like the data points 404A that were initially manually labeled. Therefore, the label quality measure of each such manually labeled data point 404B has to be recalculated just once. Furthermore, the label distribution 412B of each such manually labeled data point 404B is not updated again, which is why the updating in 706 is described as a fixable such updating. That is, the updating in 706 is fixable setting of each such manually labeled data point 404B.

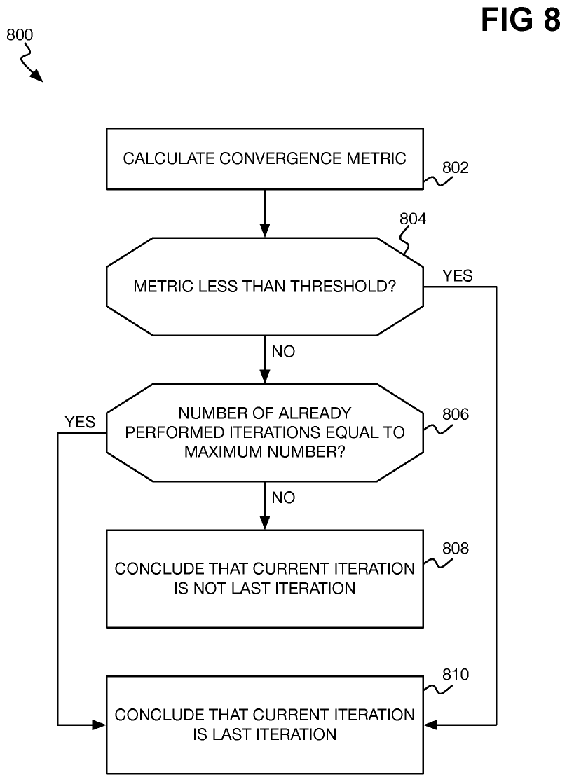

FIG. 8 shows a method 800 for determining whether convergence has been reached or the maximum number of iterations 304 have been performed in 312 of FIG. 3. The method 800 includes calculating a convergence metric (802). For example, the convergence metric can be calculated based on how much the label probability distribution 412B has converged for each data point 404B before and after having been updated in the current iteration 304. Stated another way, the convergence metric can be calculated based on how much, for each data point 404B, the label probability distribution 412B as calculated in the prior iteration 304 and as calculated in the current iteration 304 has converged.

As one example, KL divergence can be used. More generally, the convergence metric may be any measure that qualifies distance between two probability distributions. In addition to KL divergence, such measures include JS divergence, earth moving distance, and Hellinger distance. In one implementation, the average measure (e.g., KL divergence, etc.) over the set of data points 404B. In this case, in response to the convergence metric being less than a divergence threshold (804), the label probability distributions 412B of the data points 404B are considered to have sufficiently converged, and the current iteration 304 is concluded to be the last iteration 304, such that no further iterations 304 are performed (810).

In another implementation, the convergence metric is one minus the percentage of the data points 404B for which the measure (e.g., KL divergence, etc.) is less than the threshold. In this case, in response to the convergence metric is less a percentage threshold (804), then the label probability distributions 412B are similarly considered to have sufficiently converged, and the current iteration 304 is likewise concluded to be the last iteration 304, such that no further iterations are performed (810).

If the label probability distributions 114 have not yet sufficiently converged (i.e., the convergence metric is not less than a corresponding threshold) (804), but if the number of iterations 304 that have already been performed is the equal to the maximum number of iterations 304 that are to be performed (806), then the current iteration 304 is again concluded to be the last iteration 304, and no further iterations are performed (810). Just if the label probability distributions 114 have not yet sufficient converged (804) and the maximum number of iterations 304 have not yet been performed (806), is the current iteration 304 concluded to not be the last iteration 304, such that another iteration 304 is performed (808).

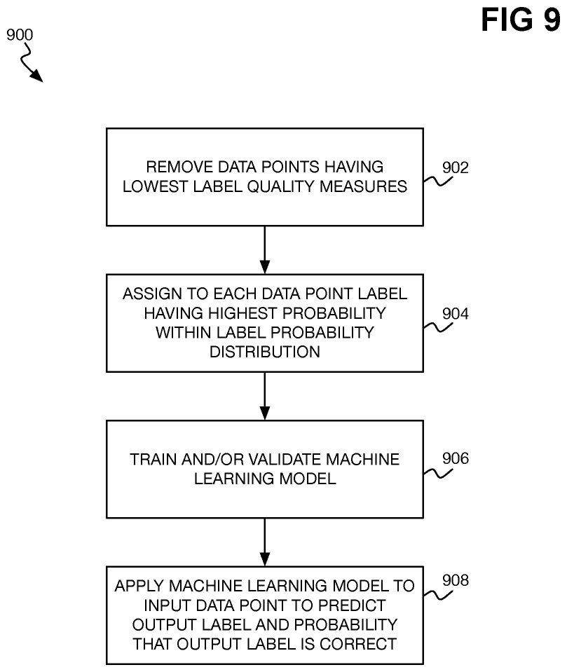

FIG. 9 shows an example method 900 for using the data points 404A and 404B after the label probability distributions 412B for the data points 404B in particular have been updated over a series of iterations 304 in FIG. 3. The method 900 thus provides the practical application of labeling the data points 404B in an automated manner via iterative updating of their label probability distributions 412B. The method 900 may be performed by the computing device 102 (such as by the processor 110).

Even after the iterations 304 have been performed, some of the data points 404B may still have low label quality measures, or at least some data points 404B will have lower label quality measures than other data points 404B. Therefore, the data points 404B having the lowest label quality measures may be removed to improve the overall quality of the set of data points 404A and 404B (902). For instance, the data points 404B having label quality measures lower than a threshold may be removed. As another example, a specified number of the data points 404B having the lowest label quality measures may be removed.

The method 900 may include assigning to each data point 404B the label having the highest probability within the label probability distribution 412B of that data point 404B (904). The data points 404A were initially manually assigned with labels, and therefore do not have to be assigned with labels in 904. Manually assigning the data points 404B with labels may be performed in scenarios in which the label probability distributions 412B themselves are not able to be used for machine learning training and/or validation.

The machine learning model 202 can then be trained and/or validated using the data points 404A and/or 404B (906). For example, a supervised machine learning model 202 may have already been trained using the data points 404A, and therefore can be validated (i.e., tested) using the data points 404B. As another example, the data points 404A and 404B may be randomly divided between training and validation sets. The training set may be used to train a supervised machine learning model 202, and the validation set may be used to validate the machine learning model 202. As a third example, an unsupervised machine learning model 202, which does not require labeled data for training, may have already been trained, and then can be validated using the data points 404B.

Once the machine learning model 202 has been trained and/or validated, the model 202 can then be applied to an input data point to predict the output label for the input data point, including the probability that the output label is correct for that input data point (908). The automated labeling of data points 404B thus provides for technological improvement in machine learning, as a way to quickly generate large amounts of accurate training data on which basis the machine learning model 202 can be trained.

This in turn means that the machine learning model 202 can be more quickly deployed in computing security and other technological environments. Moreover, insofar as the machine learning model 202 is more accurate than if fewer training data were available (because such training data may be limited to manually labeled data points and not data points labeled in an automated manner), the described techniques provide for technological improvement in the environments in which the machine learning model 202 is deployed. Security vulnerabilities and other anomalies may thus be more accurately detected as a result of the techniques that have been described.

We claim:

1. A non-transitory computer-readable data storage medium storing program code executable by a processor to perform processing comprising performing one or more iterations, each iteration comprising:
calculating, for each of a plurality of data points that each have a label probability distribution, a label quality measure based on the label probability distribution of the data point; and
updating the label probability distribution of each of at least one of the data points using either or both of a classification technique and a constrained clustering technique based on the data points and the label quality measure of each data point.

2. The non-transitory computer-readable data storage medium of claim 1, wherein each data point comprises a feature vector having a plurality of values for different features.

3. The non-transitory computer-readable data storage medium of claim 1, wherein the label probability distribution of each data point comprises a probability for each of a plurality of labels that the label is correct for the data point.

4. The non-transitory computer-readable data storage medium of claim 3, wherein the processing further comprises, before performing the iterations:
receiving the plurality of data points, including a smaller number of data points that have each been manually assigned the label that is correct for the data point and a larger number of data points that each have not been manually assigned the label that is correct for the data point;
for each of the smaller number of data points, fixably specifying the label probability distribution of the data point such that the probability for the label that has been manually assigned is set to a highest value within the label probability distribution and the probability for every other label is set to a lowest value within the label probability distribution; and
for each of the larger number of data points, initially specifying the label probability distribution of the data point as a uniform probability distribution such that the probability for every label is set to a same value within the label probability distribution.

5. The non-transitory computer-readable data storage medium of claim 3, wherein, for each data point, the label quality measure is calculated based on an entropy of the label probability distribution of the data point and an entropy of a uniform label probability distribution.

6. The non-transitory computer-readable data storage medium of claim 3, wherein updating the label probability distribution comprises using at least the classification technique, the classification technique comprising:
training a probabilistic classifier using a training subset of the data points, the probabilistic classifier trained to minimize a loss function weighted by the label quality measure of each data point of the training subset; and
applying the probabilistic classifier to each data point of the at least one of the data points to yield an updated probability for each label that the label is correct for the data point.

7. The non-transitory computer-readable data storage medium of claim 6, wherein the classification technique further comprises:
selecting the training subset of the data points,
wherein in an initial iteration, the training subset of the data points is selected as or from a smaller number of data points that each have been manually assigned the label that is corrected for the data point, and not as or from a larger number of data points that each have not been manually assigned the label that is correct for the data point.

8. The non-transitory computer-readable data storage medium of claim 7, wherein in each iteration other than the initial iteration, selecting the training subset of the data points comprises:
selecting each data point for which the label quality measure is greater than a threshold or a number of the data points for which the label quality measure is greater than the threshold.

9. The non-transitory computer-readable data storage medium of claim 3, wherein updating the label probability distribution comprises using at least the constrained clustering technique, the constrained clustering technique comprising:
clustering the data points over a plurality of clusters corresponding to the labels, such that the data points having a probability of belonging to a same cluster that is greater than a threshold are constrained to a same cluster; and
using the clusters to yield an updated probability for each label that the label is correct for each data point of the at least one of the data points.

10. The non-transitory computer-readable data storage medium of claim 9, wherein the constrained clustering technique is a soft-constrained clustering technique providing a likelihood that each data point belongs to each cluster,
and wherein, for each data point of the at least one of the data points, the updated probability for each label that the label is correct for the data point is the likelihood that the data point belongs to the cluster corresponding to the label.

11. The non-transitory computer-readable data storage medium of claim 9, wherein the constrained clustering technique is a hard-constrained clustering technique in which each data point is belongs to one of the clusters,
and wherein, for each data point of the at least one of the data points, the updated probability for each label that the label is correct for the data point is based on a quality metric that the one of the clusters to which the data point belongs corresponds to the label that is correct for the data point.

12. The non-transitory computer-readable data storage medium of claim 3, wherein each iteration further comprises:
requesting a user to manually assign the label that is correct for each of a number of the data points having lowest label quality measures; and
for each of the number of the data points having the lowest label quality measures, fixably updating the label probability distribution of the data point such that the probability for the label that has been manually assigned is set to a highest value within the label probability distribution and the probability for every other label is set to a lowest value within the label probability distribution.

13. The non-transitory computer-readable data storage medium of claim 1, wherein each iteration further comprises:
calculating a convergence metric of the label probability distribution of each data point between before having been updated and after having been updated;
in response to the convergence metric being less than a threshold, concluding that a current iteration is a last iteration, such that no further iterations are performed;
in response to the convergence metric being greater than the threshold and a number of already performed iterations being equal to a maximum number, concluding that the current iteration is the last iteration, such that no further iterations are performed; and
in response to the convergence metric being greater than the threshold and the number of already performed iterations being less than the maximum number, concluding that the current iteration is not the last iteration, such that at least one further iteration is performed.

14. The non-transitory computer-readable data storage medium of claim 1, wherein the processing further comprises, after performing the iterations:
assigning to each data point a label for which the data point has a highest probability within the label probability distribution of the data point.

15. The non-transitory computer-readable data storage medium of claim 14, wherein the processing further comprises, after performing the iterations, either or both of:
removing each data point for which the label quality measure is less than a threshold; and
removing a number of the data points having lowest label quality measures.

16. The non-transitory computer-readable data storage medium of claim 14, wherein the processing further comprises, after performing the iterations:
either or both of training and validating a machine learning model that predicts an output label for an input data point, using the data points and the label assigned to each data point.

17. The non-transitory computer-readable data storage medium of claim 16, wherein the processing further comprises, after performing the iterations:
applying the machine learning model as trained and/or validated to the input data point to predict the output label and a probability that the output label is correct for the input data point.

18. The non-transitory computer-readable data storage medium of claim 17, wherein the input data point comprises one or multiple log events of one or multiple devices, the output label corresponds to an anomaly, and the processing further comprises:
in response to the probability that the output label is correct for the input data being greater than a threshold, concluding that the one or multiple devices has the anomaly and performing an action to resolve the anomaly.

19. A method comprising:
receiving a plurality of data points, including a smaller number of data points that each have been manually assigned a label that is correct for the data point and a larger number of data points that each have not been manually assigned the label that is correct for the data point;
fixably setting a label probability distribution of each data point of the smaller number, and initially setting the label probability distribution of each data point of the larger number;
for each data point of the smaller number, calculating a label quality measure based on the label probability distribution;
for each data point of the larger number, iteratively calculating a label quality measure based on the label probability distribution and updating the label probability using either or both of a classification technique and a constrained clustering technique based on the data points and the label quality measure of each data point;
either or both of training and validating a machine learning model, using the data points and the label probability distribution of each data point; and
applying the machine learning model as trained and/or validated to an input data point to predict an output label and a probability that the output label is correct for the input data point.

20. A system comprising:
a processor; and
a memory storing program code executable by the processor to:
receive a plurality of data points, including a smaller number of data points that each have been manually assigned a label that is correct for the data point and a larger number of data points that each have not been manually assigned the label that is correct for the data point;
fixably set a label probability distribution of each data point of the smaller number and initially set the label probability distribution of each data point of the larger number;
for each data point of the smaller number, calculate a label quality measure based on the label probability distribution;
for each data point of the larger number, iteratively calculate a label quality measure based on the label probability distribution and update the label probability using either or both of a classification technique and a constrained clustering technique based on the data points and the label quality measure of each data point;
train a machine learning model using the data points and the label probability distribution of each data point;
apply the machine learning model to one or multiple log events of one or multiple devices to output a probability that the one or multiple devices have an anomaly; and
in response to the probability that the one or multiple devices having the anomaly being greater than a threshold, perform an action to resolve the anomaly.
